(19) United States
(12) Patent Application Publication
(10) Pub. No.: US 2025/0042379 A1
(43) Pub. Date: Feb. 6, 2025

(54) METHOD FOR OPERATING A BRAKE SYSTEM

(71) Applicant: Robert Bosch GmbH, Stuttgart (DE)

(72) Inventors: Florian Haag, Ellhofen (DE); Markus Schuster, Helmstadt (DE); Martin Marquart, Reichenbach (DE); Nikolas Loeffelmann, Dielheim (DE)

(21) Appl. No.: 18/696,257

(22) PCT Filed: Dec. 21, 2022
(86) PCT No.: PCT/EP2022/087300

§ 371 Date: Mar. 27, 2024

(30) Foreign Application Priority Data
Dec. 23, 2021 (DE) 10 2021 215 004.7

(51) Int. Cl. B60T 13/66; B60T 8/72; B60T 17/22

(52) U.S. Cl. CPC B60T 13/662; B60T 8/72; B60T 17/221; B60T 2270/413

(57) ABSTRACT

A method for operating a brake system and a brake system. The brake system includes a primary brake actuator and a secondary brake actuator. In the method, a brake pressure is adjusted using the primary brake actuator based on a first braking specification, and a brake pressure adjusted by the primary brake actuator is read in using a control unit of the secondary brake actuator or using an additional control unit. Then, using the control unit of the secondary brake actuator or using an additional control unit, a first plausibility check of the ascertained brake pressure is carried out with a second braking specification, which was supplied to the control unit of the secondary brake actuator or to the additional control unit.

### BACKGROUND INFORMATION

German Patent Application No. DE 10 2009 001 135 A1 describes methods for actuating a hydraulic vehicle brake system comprising an electromechanical brake booster and a wheel slip control. In this case, the vehicle brake system with the brake booster is actuated in situations in which a brake pedal is not actuated, for example for limiting a vehicle speed or controlling the distance to a preceding vehicle, or when parking.

### SUMMARY

The present invention proceeds from a method for operating a brake system and from a brake system. The brake system comprises a primary brake actuator and a secondary brake actuator. According to an example embodiment of the present invention, a brake pressure is adjusted by means of the primary brake actuator on the basis of a first braking specification. A brake pressure adjusted by means of the primary brake actuator is furthermore read in by means of a control unit of the secondary brake actuator or by means of an additional control unit. By means of the control unit of the secondary brake actuator or by means of an additional control unit, a first plausibility check of the ascertained brake pressure is carried out with a second braking specification, which was supplied to the control unit of the secondary brake actuator or to the additional control unit.

According to an example embodiment of the present invention, a first brake actuator can be present in the form of an electromotive hydraulic actuator, for example in the form of a plunger, or of an electrical brake booster. Plungers or brake boosters can generate a brake pressure via a hydraulic piston/cylinder arrangement, for example a master brake cylinder, by shifting an actuating element by motor power. A second brake actuator can, for example, be a hydraulic unit used in vehicle stabilization systems such as ESPs or within the framework of traction control. A braking specification can be an indication as to how much the vehicle is to be decelerated in the present driving situation. The braking specification can be provided by a driver who specifies their intention to brake, in particular the extent to which they want to brake, by actuating a brake input element. A brake input element can, for example, be a lever, a pedal, or another type of input element. A braking specification can also come from control units of the vehicle, for example from a control unit for automatic distance control, for a hill hold control, or for vehicle stabilization in general. A driver-dependent and a driver-independent braking specification are thus possible.

According to an example embodiment of the present invention, it is advantageous if a first braking specification and a second braking specification are present in the brake system, which are each provided separately to the first brake actuator and to the second brake actuator. By separately assigning the braking specification to the first and second brake actuators, a plausibility check of the conversion of the braking specification into a brake pressure is made possible, wherein mainly an increased failure safety for the entire brake system is provided. It is thus possible, mainly in the case of a negative plausibility check, to respond adequately to an existing error in the brake system. Such a failure safety is particularly important for so-called brake-by-wire systems, which admittedly convert a driver-dependent braking specification, which is however generally transmitted only electronically to the respective brake actuators present. In this case, hydraulic brake pressure generation by the driver themselves, in particular by the muscular power of the driver, is often no longer provided.

In an embodiment of the method of the present invention, in the case of a negative first plausibility check, a second plausibility check takes place by means of a control unit of the secondary brake actuator or by means of an additional control unit. As part of the second plausibility check, a deceleration signal of the vehicle is checked using the second braking specification. If it is assumed that it has been found as part of the first plausibility check that the first brake pressure resulting in the brake system does not match the present second braking specification, and if the present deceleration signal is subsequently checked, an allocation of an error can take place therefrom. This has the advantage that, when an error is allocated, adequate fallback levels of the brake system can be called, resulting in increased safety when operating the brake system.

In an embodiment of the method of the present invention, the first braking specification and the second braking specification are identical. In this case, the first braking specification and the second braking specification can be based on an identical source. In the case of a driver-dependent braking specification, an identical source can, for example, be understood to mean the same sensor, which specifies the extent of the pedal actuation by the driver. It is also possible that, for increasing the redundancy, the same variable is ascertained but via two independent sensors. In the case of a driver-independent braking specification, the first and the second braking specification can be based on the same function in a control unit.

As already mentioned for explanation, the first braking specification and the second braking specification may be a driver-dependent or also a driver-independent braking specification. This increases the variance in systems in which the method can be used.

In a further embodiment of the method of the present invention, the second plausibility check can be used to allocate an error in the vicinity of the primary brake actuator if the second plausibility check of the braking specification with the deceleration signal is negative. Thus, if the prevailing brake pressure does not match the braking specification which is available to the control unit of the secondary brake actuator or to the additional control unit and if the present deceleration signal also does not match the braking specification which is available to the control unit of the secondary brake actuator or to the additional control unit, it can be assumed for error allocation that a fault is present in the vicinity of the primary brake actuator. This has the advantage that a delimitation of possible errors in the interplay between the primary and secondary brake actuators can take place, which offers the possibility of an adequate measure for compensation and thus increases the safety of the brake system.

Advantageously, according to an example embodiment of the present invention, depending on the error allocation in the vicinity of the primary brake actuator, a corresponding replacement response to brake the vehicle can be triggered. A first replacement response can be that a brake pressure adjustment takes place by means of the secondary brake actuator and/or is continued by means of the secondary brake actuator. It is thus possible despite a defective primary brake actuator to still carry out a sufficient braking process, or to continue a braking process, resulting in increased safety.

In a further embodiment of the present invention, the second plausibility check is used to allocate an error in the vicinity of the secondary brake actuator, in particular in the vicinity of the brake pressure determination, in the vicinity of the pressure sensor, or in the vicinity of the pressure sensor signal, if the second plausibility check of the braking specification with the deceleration signal is positive. It is thus possible by means of the first and second plausibility checks to locate an error in the vicinity of the secondary brake actuator, which is important in order nevertheless to be able to continue to use the brake system.

According to an example embodiment of the present invention, it is furthermore advantageous that, depending on the error allocation, a corresponding replacement response for braking the vehicle is triggered, wherein, as a second replacement response, a brake pressure adjustment by means of the secondary brake actuator is prevented, in particular to the extent that the brake pressure adjustment takes place using the pressure sensor signal. This makes it possible to prevent a use of the secondary brake actuator if the latter is at least partially defective, or to prevent at least the use of the affected portions of the secondary brake actuator that use a pressure signal for brake pressure adjustment.

In an example embodiment of the method of the present invention, the first plausibility check takes place on the basis of a first type of characteristic curves and/or characteristic maps, which define a relationship between the brake pressure and the first or the second braking specification. Stored and/or ascertained characteristic curves or characteristic maps can be used to store an expected brake pressure in the vehicle, which brake pressure is expected in the case of a first and/or second braking specification.

In a further embodiment of the method of the present invention, the second plausibility check takes place on the basis of a second type of characteristic curves and/or characteristic maps, which define a relationship between the vehicle deceleration and the first or the second braking specification. Stored and/or ascertained characteristic curves or characteristic maps can be used to store an expected deceleration in the vehicle, which deceleration is expected in the case of a first and/or second braking specification.

According to an example embodiment of the present invention, as part of the method, a check can take place for an existing error signal that has been set by the primary brake actuator. Thus, it can first be ruled out that the primary brake actuator itself is already defective and also has already indicated this to the secondary brake actuator via communication channels. A fault can thus be explicitly detected and also adequately recognized and handled if an error has not already been transmitted. Thus, if an already transmitted error is not present, the monitoring proceeds as in the method described above.

Advantageously, according to an example embodiment of the present invention, the additional control unit can be an onboard or an off-board additional control unit. It is thus also possible to use additional control unit architectures, for example shared control units, which are actually otherwise distributed to two control units. Higher-level vehicle computers or vehicle control units can also be used. It is also possible that an external computer or an external control unit is used and the method runs at least partially outside the vehicle, for example in a cloud.

In an example embodiment of the method of the present invention, at least the brake pressure, the deceleration signal, and the first or second braking specification are supplied via communication means, in particular via off-board or onboard communication means, to the additional control unit for evaluation, or they are already available to the additional control unit.

The present invention furthermore relates to a brake system for a vehicle comprising a primary brake actuator and a secondary brake actuator, wherein a brake pressure can be adjusted by means of the primary brake actuator on the basis of a first braking specification, a brake pressure adjusted by means of the primary brake actuator can be read in by means of a control unit of the secondary brake actuator or by means of an additional control unit, and a first plausibility check of the ascertained brake pressure with a second braking specification can be carried out by means of the control unit of the secondary brake actuator or by means of an additional control unit, which second braking specification was supplied to the control unit of the secondary brake actuator or to the additional control unit.

In an example embodiment of the brake system of the present invention, in the case of a negative first plausibility check, a second plausibility check can be carried out by means of a control unit of the secondary brake actuator or by means of an additional control unit, using the second braking specification and a deceleration signal.

### BRIEF DESCRIPTION OF THE DRAWINGS

FIG. 1 shows a brake system of a vehicle, according to an example embodiment of the present invention.

FIG. 2 shows a flowchart of a method for operating a brake system of a vehicle, according an example embodiment of the present invention.

FIG. 3 and FIG. 4 each show a characteristic curve, which shows a braking specification in relation to a brake pressure and a deceleration signal, respectively, according to an example embodiment of the present invention.

### DETAILED DESCRIPTION OF EXAMPLE EMBODIMENTS

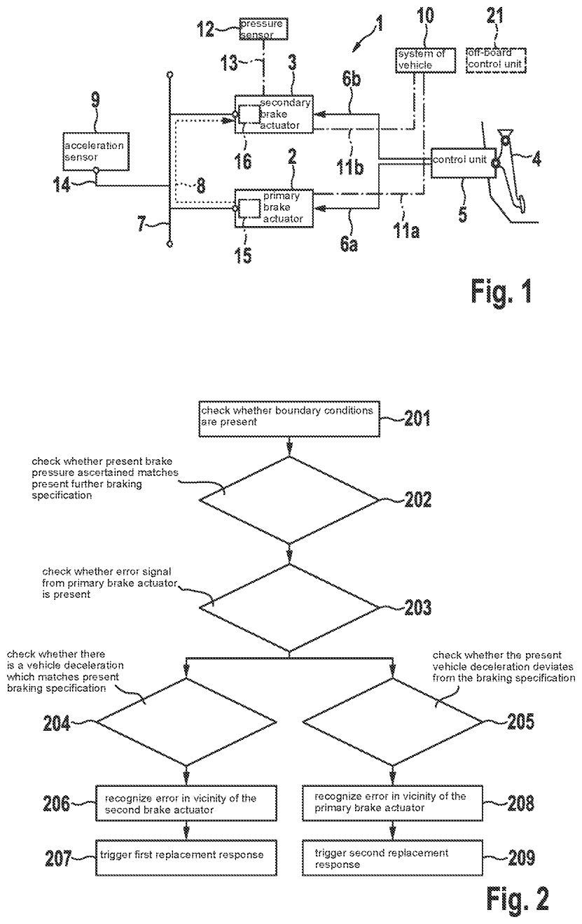

FIG. 1 shows a schematic representation of a brake system 1 of a motor vehicle. The brake system 1 comprises a primary brake actuator 2 and a secondary brake actuator 3. A primary brake actuator 2 can, for example, be an electromechanical brake actuator 2, which can generate a brake pressure in wheel brakes of a vehicle by means of a hydraulic fluid. Such a hydraulic pressure can, for example, be generated in a master brake cylinder of a motor vehicle. A secondary brake actuator 3 is generally hydraulically downstream of such a master brake cylinder. Such a secondary brake actuator 3 can, for example, be a hydraulic unit of a brake pressure modulation unit. A brake pressure modulation unit can, for example, be understood to mean an ESP system. A primary brake actuator can also be understood to mean an electrically actuated plunger piston, which can likewise bring about a brake pressure build-up in connected wheel brakes. In contrast to a brake booster, in the case of such a plunger system, the electrically actuated plunger and the driver do not jointly act on the wheel brakes, at least not in normal operation. Rather, the driver acts on a pedal simulator and thereby generates a braking specification/a braking request, wherein this braking specification is then implemented at the wheel brakes by the electrically actuated plunger.

The brake system is able to provide a brake pressure both driver-dependently and driver-independently.

In the case of a driver-independent braking specification, the braking specification is generated by a system 10 of the vehicle. In this case, a braking request by the system is generally implemented. Examples of such systems inter alia include hill hold controls, stop-and-go driving, or automatic distance control. Brake actuation, for example via a brake pedal by the driver, is not directly converted into a braking effect but can be taken into account. The system 10 can in this case be a system 10 at an equivalent level to the brake system 1, for example a driver assistance system with suitable distance sensors and environmental detection sensors, or a higher-level system 10, for example an overall vehicle control system, which comprises the brake system and the driver assistance system or is connected to and communicates with these systems via communication means.

In the case of a driver-dependent braking specification, the brake pressure generated by the primary 2 or by the secondary 3 brake actuator depends on an actuation of an actuation element 4 by the driver, for example via an actuation of a brake pedal 4. This actuation is then converted into a corresponding brake pressure by means of the primary and/or secondary brake actuator 2, 3. A braking request specification from the driver can also take place via other actuation elements 4, for example via a rotary knob, a slider, or a lever.

A braking specification via the actuation element 4 can take the form of an extent of the actuation of the actuation element 4 by the driver and is ascertained by a control unit 5 by means of suitable sensors. A variable for ascertaining the driver specification can, for example, be a deflection path and/or an actuating force. A variable for ascertaining the driver specification can also be or be derived from a variable based on the deflection path and/or actuating force.

The control unit 5 passes the driver-dependent braking specification to the respective control units 15 and 16 of the primary 2 and the secondary brake actuator 3 in the form of the driver specification 6a to the control unit 15 of the primary brake actuator 2 and in the form of the driver specification 6b to the control unit 16 of the secondary brake actuator 3, respectively. In this case, the braking specifications 6a and 6b are identical variables and are supplied to the primary brake actuator 2 and the secondary brake actuator 3, respectively, for redundancy purposes.

The further system 10 passes the driver-independent braking specification 11a and 11b to the respective control units 15, 16 of the primary 2 and the secondary brake actuator 3 in the form of the driver specification 11a to the control unit 15 of the primary brake actuator 2 and in the form of the driver specification 11b to the control unit 16 of the secondary brake actuator 3, respectively. The braking specifications 11a and 11b are also identical variables and are supplied to the primary brake actuator 2 and the secondary brake actuator 3, respectively, for redundancy purposes.

Below, the term “braking specification” is used both in the case of a driver-dependent braking specification 6a, 6b and in the case of a driver-independent braking specification 11a, 11b.

The control units 15 and 16 of the primary 2 and secondary 3 brake actuators are connected to one another via a communication system 7, for example via a communication bus 7. The brake actuators 2, 3 involved can directly exchange signals with one another via such a communication system 7. For example, the primary brake actuator 2 can thus transmit an error state 8 directly to the secondary brake actuator 3. If the primary brake actuator 2 transmits an error state 8 to the secondary brake actuator 3, the secondary brake actuator 3 can, for example, take over or continue a braking process previously carried out by or with the primary brake actuator 2. Such a function is also referred to as hydraulic boost compensation HBC.

Brake interventions in vehicles generally manifest in a change in the vehicle speed, i.e., in the form of an acceleration and/or a deceleration. An acceleration and/or a deceleration can be sensed by means of an acceleration sensor 9. An acceleration signal 14 of an acceleration sensor 9 can be provided via the communication system 7 at different locations in the vehicle, for example also in the primary 2 and/or the secondary brake actuator 3, and there to the respective control units 15 and 16, respectively.

In the now described application, a failure of the primary brake actuator 2 is to be recognized by means of the secondary brake actuator 3. In particular, this recognition is to take place independently of a transmission of the error state 8 by the primary brake actuator 2 itself.

In the control unit 16 of the secondary brake actuator 3, the brake pressure 13 built up by means of the primary brake actuator 2 is monitored. The brake pressure built up by means of the primary brake actuator 2 can be ascertained by means of a pressure sensor 12 of the brake system 1, which pressure sensor can sense the resulting pressure 13 in the master brake cylinder of the brake system 1.

The sensed brake pressure can then be compared in the control unit 16 of the secondary brake actuator 3 to a present, driver-dependent or driver-independent, braking specification 6b, 11b. Such a comparison can, for example, take place by means of a characteristic map or a characteristic curve, which has been stored in the vehicle in advance. Such a characteristic map or such a characteristic curve does not necessarily have to be provided in the vehicle in a fixed manner; it can also be updated during ongoing operation or at certain intervals, for example when the ignition is switched on or during inspections. Such characteristic curves or characteristic maps can also be adapted by selecting a driving mode of the vehicle. For example, a vehicle can be operated in a sports mode and in a comfort mode via a selector switch in the vehicle.

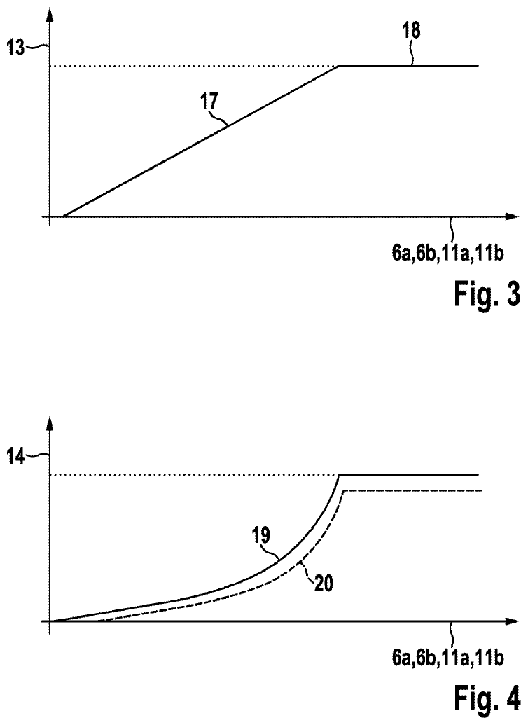

An example of a characteristic curve 17 is shown in FIG. 3. FIG. 3 shows a course of the characteristic curve for the brake pressure 13 as a function of the braking specification 6a, 6b, 11a, 11b. Initially, the brake pressure 13 increases with increasing braking specification 6a, 6b, 11a, 11b, and then reaches a pressure level where the primary brake actuator 2 is no longer capable of continuing the brake pressure build-up. This is also referred to as achieving a control pressure 18. Such characteristic curves 17 for driver-dependent and driver-independent braking specifications 6a, 6b, 11a, 11b may be specified to be identical but also to be different from one another. Only one characteristic curve 17 is shown here by way of example.

If the brake pressure 13 adjusted on the basis of the braking specification 6a, 11a by means of primary brake actuator 2 deviates from a target brake pressure expected on the basis of the characteristic curve 17 or of the characteristic map, this indicates an error in the brake system 1.

On the one hand, a failure and/or an error of the primary brake actuator 2 may be present. On the other hand, an error in the pressure sensor 12, the signal transmission of the pressure sensor 12 and/or in the signal processing of the pressure sensor 12 in the secondary brake actuator 3 may be present.

The following describes how an error assignment can take place, which then results in a corresponding replacement response.

The vehicle deceleration 14 ascertained by means of the sensor 9 can be used. The vehicle deceleration 14 is analyzed with the braking request specification 6b or 11b of the secondary brake actuator 3.

For such an analysis, a plausibility check of the further braking specification 6b, 11b available in the control unit 16 of the secondary brake actuator 3 together with a vehicle deceleration 14 can take place. This plausibility check takes place on the basis of a characteristic curve and/or a characteristic map. An example of a deceleration/braking specification characteristic curve 19 is shown in FIG. 4, which shows a relationship between the deceleration 14 and the braking specification 6a, 6b, 11a, 11b. In other words, the expected vehicle deceleration 14 is plotted over a present braking specification 6a, 6b, 11a, 11b, wherein the braking specification can be driver-dependent (6a, 6b) or driver-independent (11a, 11b).

The characteristic curve 19 shown can be increasing with increasing slope at higher braking specifications and can reach a plateau corresponding to a control pressure of the primary brake actuator 2, as already described above for the characteristic curve of the brake pressure.

The further characteristic curve 20 is used to clarify that the check as to whether the vehicle deceleration 14 matches the braking specification 6b, 11b, i.e., in other words, the plausibility check, can take place within the framework of certain tolerances/certain tolerance ranges. In contrast to the characteristic curve 19, the characteristic curve 20 takes into account further variables representing the current driving state of the vehicle. In this case, further variables can be included in the calculation or determination of the characteristic curve. Suitable as such variables are inter alia: the vehicle weight, the prevailing brake friction coefficients, the roadway slope, and the road friction values. These variables are often present in the vehicle as estimated values, which reflect the current driving situation. Since the variables are often estimated variables, a certain tolerance range of the characteristic curve is required.

A sequence of the method for operating the brake system 1 is described below on the basis of FIG. 2.

It is assumed that, in this operating situation, the primary brake actuator 2 is solely responsible for building up the pressure.

In a first step 201, it is checked whether the boundary conditions for monitoring the braking specification 6b, 11b and the brake pressure 13 in the secondary brake actuator 3 are present. Such boundary conditions can be an operating state of the pressure sensor 12, the validity of the braking specifications 6a, 11a to the control unit of the primary brake actuator 2 or of the braking specifications 6b, 11b to the control unit of the secondary brake actuator 3, and exclusion of driving states of the vehicle that invalidate a monitoring of the braking specification or lead to an incorrect result (e.g., standstill and degradations of the primary brake actuator). Such driving states can have the effect that the intended dependence between braking specification and brake pressure and thus also between braking specification and vehicle deceleration cannot be achieved from the outset.

In a step 202, it is checked whether the present brake pressure 13, which was ascertained in the secondary brake actuator 3, matches the present further braking specification 6b, 11b, which is present in the control unit 16 of the secondary brake actuator 3. As already described, this takes place on the basis of existing characteristic curves 17 and/or characteristic maps. A relationship between the brake pressure 13 and the braking specification 6b, 11b is stored in the vehicle via the characteristic curves 17 and/or characteristic maps. The monitoring of the brake pressure specification 11b, 6b and of the brake pressure 13 can be activated permanently on the control unit 16.

The monitoring function in the secondary brake actuator 3 can take into account a time filter or additional activation conditions, such as pump activities or valve activities in the secondary brake actuator 3. A control of pumps and/or valves in the secondary brake actuator 3 can result in pressure spikes or brief implausible pressure values, which could interfere in the monitoring.

If there is a deviation between the further braking specification 6b, 11b and the brake pressure stored on the basis of the characteristic curves 17 and/or characteristic maps, the method continues in step 203. In this case, a deviation within certain limits can also be tolerated, which can, for example, be stored in the form of threshold values for the deviation. In this case, the method is not continued in step 203 until a threshold value for the deviation is exceeded. The tolerances/threshold values are not shown in FIG. 3.

In step 203, it is checked whether an error signal 8 from the primary brake actuator 2 itself is already present. If this is not the case, the method can continue to run in two different branches. If an error signal 8 from the primary brake actuator is already present, the method ends. It is possible in this case that the secondary brake actuator 3 then takes over or has already taken over the brake pressure adjustment via the further braking specification 6b, 11b.

Both continuing branches, 204, 206, 207 and 205, 208, 209, respectively, use the present driving situation on the basis of the present vehicle deceleration 14, ascertained as described above with the acceleration sensor 9. In so doing, it is checked whether there is a vehicle deceleration 14 which matches the braking specification 6b, 11b (step 204) or whether the present vehicle deceleration deviates from the braking specification 6b, 11b (step 205).

If the present vehicle deceleration 14 matches the braking specification 6b, 11b (step 204), an error in the vicinity of the secondary brake actuator 3 is recognized (step 206). In particular, an error in the brake pressure determination of the brake pressure 13 can be recognized. In this case, it should be noted that there is a deviation between the braking specification 6b, 11b and the measured brake pressure 13, but the vehicle deceleration 14 matches the braking specification 6b, 11b. It can therefore be assumed that the error is not in the region of the primary brake actuator 2. An error allocation in this case indicates a defective pressure sensor 12 or an error in the signal processing of the pressure sensor 12.

As a result (step 207), a first replacement response is triggered, in which continued operation of the secondary brake actuator 3 is prevented or is prevented at least to the extent to which the secondary brake actuator uses signals from the pressure sensor 12.

Continued operation of the secondary brake actuator 3 can however continue to take place on the basis of a p-V characteristic curve, which shows the built-up pressure in the brake system in relation to the volume of brake fluid displaced into the brake system 1. For example, the volume V introduced by the primary brake actuator 2 can be ascertained from the travel of the primary actuator 2. A torque estimation of the primary actuator 2 can also take place, which is intact in these situations after all. Via these variables mentioned, a pressure estimation can then take place, which can be used to operate the secondary actuator as needed. Examples include functions such as standard pressure building methods in the ESP, for example for vehicle hold or stability interventions in the ESP.

If the present vehicle deceleration 14 does not match the braking specification 6b, 11b (step 205), an error in the vicinity of the primary brake actuator 2 is recognized (step 208). In this situation, neither the brake pressure 13 nor the vehicle deceleration 14 matches the braking specification.

As a result, a second replacement response is triggered (step 209), by means of which the brake pressure adjustment then takes place by the secondary brake actuator 3 and no longer by the primary brake actuator 2. The brake pressure adjustment by the secondary brake actuator 3 is in this case based on the further braking specification 6b, 11b.

In the above-described embodiment, it was assumed that the monitoring of the brake pressure 13 and the plausibility check of the brake pressure with the braking specification 6b, 11b take place in the control unit 16 of the secondary brake actuator 3.

In other embodiments, it is however possible that the analysis as to whether the brake pressure 13, which is generated by means of the primary brake actuator 2 and is ascertained by means of the secondary brake actuator 3 and an assigned brake pressure sensor 12, matches the braking specification 6b, 11b also takes place on control units other than the control unit 16 of the second brake actuator 3.

On the one hand, another control unit located in the vehicle, for example a control unit 10 which is actually responsible for driver assistance functions or, alternatively, a higher-level control unit, which is, for example, a central computer of the vehicle, can take over this analysis function. The data required to carry out the analysis on an additional control unit, for example the brake pressure 13 and the braking specification 6b, 11b, can be provided to the additional control unit 10 via suitable communication channels, for example via the communication network 7 (bus system); wireless data transfer within the vehicle is also possible.

The analysis as to whether the present vehicle deceleration matches the braking specification 11b, 6b can also take place as part of the error allocation in an additional control unit, for example vehicle computer 10 and/or driver assistance control unit 10.

It is also possible that the analysis as to whether the achieved brake pressure 13 corresponds to the braking specification 6b, 11b takes place outside the vehicle, for example in an off-board control unit 21 or computer, wherein the off-board control unit 21 or the computer then uses corresponding data of the vehicle. Such data would be the achieved brake pressure 13 and the braking specification 6b, 11b. An off-board control unit 21 or computer can also check whether the present vehicle deceleration matches the braking specification 11b, 6b. For this purpose, the braking request specification 6b, 11b can also be provided directly to the off-board control unit 21 or computer. It is however also possible that the braking specification 6b, 11b continues to be provided to the secondary brake actuator 3 and is transmitted by the latter to the off-board control unit 21 or computer.

A data transfer to off-board control units, for example to a cloud, can take place via suitable communication means, for example data connections via the internet.

A replacement response in the event of a failure of the primary brake actuator 2 as shown in the first embodiment, can in this case continue to be carried out with the secondary brake actuator 3, both in the case of additional control units 10 within the vehicle and in the case of off-board control units 21 or computers.

In the event that the brake system 1 comprises further brake components in addition to the hydraulic actuators, i.e., in addition to the primary brake actuator 2 and the secondary brake actuator 3, these components can likewise be used for a replacement response. Such further brake components can, for example, be an electrically actuatable parking brake, an electromotive brake arranged on at least one wheel to be braked, or a generator of an electric vehicle or hybrid vehicle which produces a braking effect during recuperation.

Previously, a deceleration signal 14 was mentioned, which may also be not directly measured but derived from other variables, for example from measurements with inertial sensors or wheel speed sensors or also derived from a position determination system.

In summary, it can be said that the fact that 2 braking specifications 6a, 6b, or 11a, 11b are provided at different locations in the brake system, which braking specifications are then checked for plausibility by means of a present brake pressure and are further analyzed for error allocation by means of a present vehicle deceleration, makes it possible that a failure of a primary brake actuator can be reliably recognized and can be taken into account by means of an adequate replacement response.

It is also possible that the monitoring of the brake pressure is anchored in the primary brake actuator 2; the primary brake actuator would thus monitor itself, but on the basis of the brake pressure 13 ascertained with the secondary brake actuator 3. The braking specification 6a, 11a present in the primary brake actuator is converted according to a function, for example a characteristic curve, into a target pressure to be provided by the primary brake actuator 2. The primary brake actuator 2 receives the pressure measured by the secondary brake actuator 3. In an internal monitoring function of the primary brake actuator, the target brake pressure is now continuously compared to the achieved pressure.

The monitoring function in the primary brake actuator 2 can take into account a time filter or additional activation conditions, such as pumps or valve activities in the secondary brake actuator 3. A control of pumps and/or valves in the secondary brake actuator can result in pressure spikes/brief implausible pressure values, which could interfere in the monitoring.

If the difference between the target pressure and the actual pressure exceeds or falls below a defined threshold value, this means that the primary brake actuator 2 was not or was not sufficiently able to implement the braking specification. In this situation, a degradation of the primary brake actuator and an associated transfer to the secondary brake actuator are then required.

The primary brake actuator 2 degrades itself and thus initiates the transfer to the secondary brake actuator 3.

1-15. (canceled)

16. A method for operating a brake system including a primary brake actuator and a secondary brake actuator, the method comprising the following steps:
adjusting a brake pressure using the primary brake actuator based on a first braking specification;
reading in, using a control unit of the secondary brake actuator or an additional control unit, the brake pressure adjusted using the primary brake actuator; and
performing a first plausibility check of the read-in brake pressure, using the control unit of the secondary brake actuator or the additional control unit, with a second braking specification which was supplied to the control unit of the secondary brake actuator or to the additional control unit.

17. The method according to claim 16, wherein, in the case of a negative first plausibility check, a second plausibility check takes place using the control unit of the secondary brake actuator or the additional control unit, using the second braking specification and a deceleration signal.

18. The method according to claim 16, wherein the first braking specification and the second braking specification are identical, and wherein the first braking specification and the second braking specification have an identical source.

19. The method according to claim 18, wherein the first braking specification and the second braking specification are driver-dependent or driver-independent braking specifications.

20. The method according to claim 17, wherein an allocation of an error in a vicinity of the primary brake actuator takes place based on the second plausibility check when the second plausibility check with the second braking specification and the deceleration signal is negative.

21. The method according to claim 20, wherein, depending on the error allocation, a corresponding replacement response for braking the vehicle is triggered, wherein, as a first replacement response, a brake pressure adjustment takes place using the secondary brake actuator and/or is continued using the secondary brake actuator.

22. The method according to claim 17, wherein an allocation of an error in a vicinity of the secondary brake actuator takes place based on the second plausibility check, the vicinity of the secondary brake actuator including a vicinity of a brake pressure determination, or in a vicinity of a pressure sensor or in a vicinity of a pressure sensor signal, when the second plausibility check with the second braking specification and the deceleration signal is positive.

23. The method according to claim 22, wherein, depending on the error allocation, a corresponding replacement response for braking the vehicle is triggered, wherein, as a second replacement response, a brake pressure adjustment using the secondary brake actuator is prevented, to the extent that the brake pressure adjustment takes place using the pressure sensor signal.

24. The method according to claim 16, wherein the first plausibility check takes place based on a first type of characteristic curves and/or characteristic maps, which define a relationship between the brake pressure and the second braking specification.

25. The method according to claim 17, wherein the second plausibility check takes place based on a second type of characteristic curves and/or characteristic maps, which define a relationship between a vehicle deceleration and the second braking specification.

26. The method according to claim 16, wherein a check takes place for an existing error signal set by the primary brake actuator.

27. The method according to claim 16, wherein the additional control unit is an onboard additional control unit or an off-board additional control unit.

28. The method according to claim 27, wherein, at least the brake pressure, a deceleration signal, and the first or second braking specification are: (i) supplied via an off-board or onboard communication arrangement, to the additional control unit for evaluation, or (ii) already available to the additional control unit.

29. A brake system for a vehicle, comprising:
a primary brake actuator; and
a secondary brake actuator;
wherein:
a brake pressure can be adjusted using the primary brake actuator on the basis of a first braking specification,
the brake pressure adjusted using the primary brake actuator can be read in using a control unit of the secondary brake actuator or an additional control unit, and
using the control unit of the secondary brake actuator or the additional control unit, a first plausibility check of the ascertained brake pressure can be carried out with a second braking specification, which was supplied to the control unit of the secondary brake actuator or to the additional control unit.

30. The brake system according to claim 29, wherein, in the case of a negative first plausibility check, a second plausibility check can be carried out using the control unit of the secondary brake actuator or the additional control unit, using the second braking specification and a deceleration signal.
